(19) United States
(12) Patent Application Publication
(10) Pub. No.: US 2025/0206125 A1
(43) Pub. Date: Jun. 26, 2025

(54) VEHICLE REAR STRUCTURE

(71) Applicant: TOYOTA JIDOSHA KABUSHIKI KAISHA, Toyota-shi (JP)

(72) Inventor: Masahiro URAGO, Toyota-shi (JP)

(73) Assignee: TOYOTA JIDOSHA KABUSHIKI KAISHA, Toyota-shi (JP)

(21) Appl. No.: 18/991,515

(22) Filed: Dec. 21, 2024

(30) Foreign Application Priority Data
Dec. 25, 2023 (JP) 2023-217592

(51) Int. Cl. B60K 1/04; B62D 21/02

(52) U.S. Cl. CPC B60K 1/04; B62D 21/02; B60K 2001/0416; B60K 2001/0438

(57) ABSTRACT

A rear structure of the vehicle comprises a battery disposed under the deck board, a rear cross member disposed at rear side of the battery, and a support member disposed at rear side of the rear cross member and configured to support the deck board. The support member has a structure comprising a plurality of vertical ribs extending in both the vertical direction and the vehicle longitudinal direction and a plurality of horizontal ribs extending in both the vehicle width direction and the vehicle longitudinal direction. The structure has a portion located directly behind the battery, and a distance is secured in the vehicle longitudinal direction between the front end of the portion and the rear end of the battery,

### CROSS REFERENCE TO RELATED APPLICATION

This application claims priority to Japanese Patent Application No. 2023-217592 filed on Dec. 25, 2023, which is incorporated herein by reference in its entirety including the specification, claims, drawings, and abstract.

### TECHNICAL FIELD

The present disclosure relates to a vehicle rear structure in which a battery is arranged under a deck board constituting a floor of a rear luggage room in a vehicle.

### BACKGROUND

JP 2019-051885 A discloses a vehicle rear structure in which a battery is arranged under a deck board constituting a floor of a rear luggage room in a vehicle.

In vehicles where a battery is disposed under a deck board constituting a floor of a rear luggage room in a vehicle, a support member that supports a rear end of the deck board is disposed at a rear side of the battery. However, if the support member is pushed forward due to a rear-end collision, there is a possibility that it will collide with the battery and move or damage it. In order to avoid such interference of the support member with the battery, it is necessary to reduce the thickness of the support member in the vehicle longitudinal direction. However, if the thickness of the support member in the vehicle longitudinal direction is reduced across the entire width of the vehicle, the rigidity of the support member will decrease in response to the load applied by the luggage placed on the deck board.

Given the above circumstances, an advantageous effect of the present disclosure is to provide a vehicle rear structure that can ensure the rigidity of the support member against the load applied by the luggage placed on the deck board, while avoiding interference of the support member with the battery in the event that the support member disposed at a rear side of the battery is pushed forward due to a rear collision.

### SUMMARY

According to an aspect of the present disclosure, a vehicle rear structure includes a battery disposed under a deck board constituting a floor of rear luggage room in a vehicle, a rear cross member which is disposed at a rear side of the battery and extends along the vehicle width direction, and a support member which is disposed at a rear side of the rear cross member and configured to support the deck board. The support member has a structure comprising a plurality of vertical ribs extending in both the vertical direction and the vehicle longitudinal direction and a plurality of horizontal ribs extending in both the vehicle width direction and the vehicle longitudinal direction, the plurality of vertical ribs intersecting the plurality of horizontal ribs in a forward part of the support member. The structure has a portion located directly behind the battery, and a distance is secured in the vehicle longitudinal direction between the front end of the portion and the rear end of the battery, to prevent interference of the portion with the battery even when the support member is pushed forward due to a rear-end collision to a location where the support member contacts a rear surface of the rear cross member.

According to an aspect of this disclosure, in the vehicle rear structure, the structure may be formed such that the front end of the portion of the structure located directly behind the battery is rearwardly recessed relative to the front end of another portion that is not located directly behind the battery.

According to an aspect of this disclosure, in the vehicle rear structure, the support member may be designed to contact an upper surface of the rear cross member for allowing the support member to be supported by the rear cross member.

If the support member is designed to contact an upper surface of the rear cross member, the performance of the support members can be improved so that they do not collapse forward under the load applied by the luggage placed on the deck board.

The present disclosure can provide the vehicle rear structure that can ensure the rigidity of the support member against the load applied by the luggage placed on the deck board, while avoiding interference of the support member with the battery in the event that the support member disposed at a rear side of the battery is pushed forward due to a rear collision.

### BRIEF DESCRIPTION OF DRAWINGS

Embodiments of the present disclosure will be described based on the following figures, wherein:

FIG. 1 is a top view of a vehicle rear structure according to the embodiment;

FIG. 2 is a cross-sectional view of line A-A in FIG. 1; and

FIG. 3 is an oblique view of the vehicle rear structure according to the embodiment.

### DESCRIPTION OF EMBODIMENTS

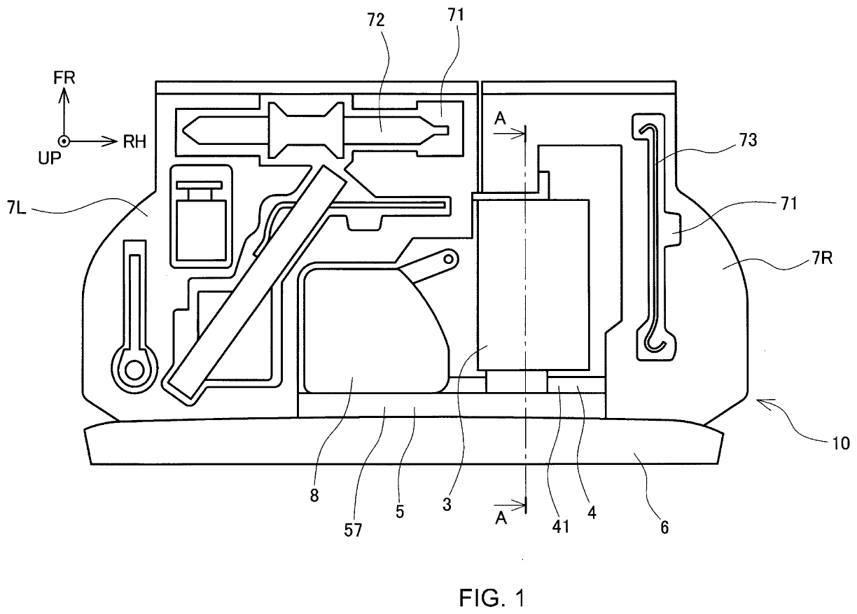

The following describes the vehicle rear structure 10 of the embodiment according to the present disclosure, with reference to FIGS. 1 to 3. Arrows FR, UP, and RH shown in the drawings which will be referenced in the following explanation represent a forward direction (a travel direction), an upward direction, and a right hand direction of a vehicle, respectively. Further, directions opposite to those indicated by the arrows FR, UP, and RH represent a rearward direction, a downward direction, and a left hand direction of the vehicle, respectively. Hereinafter, unless otherwise specified, descriptions simply using terms of forward, rearward, right, left, upward, downward, and the like will denote forward or rearward in a vehicle longitudinal direction, right or left in a vehicle lateral direction (vehicle width direction), and upward or downward in a vehicle vertical direction.

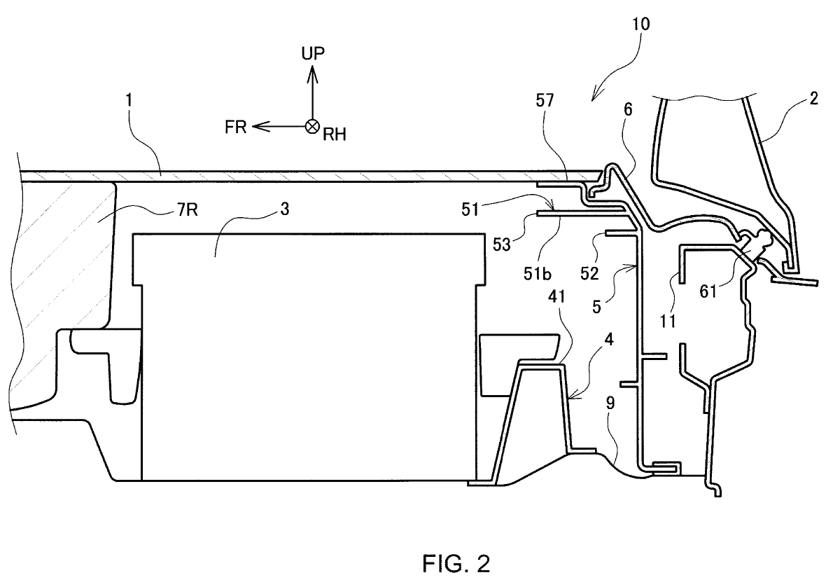

FIG. 1 is a top view of a vehicle rear structure 10 in the embodiment. FIG. 2 is a cross-sectional view of line A-A in FIG. 1. However, FIG. 2 shows the deck board 1 constituting a floor of a rear luggage room in a vehicle and the back door 2, but FIG. 1 omits the description of the deck board 1 and the back door 2. As shown in FIGS. 1 and 2, the vehicle rear structure 10 includes a battery 3, a rear cross member 4, and a support member 5. The battery 3 is disposed in the vehicle longitudinal direction under the deck board 1. The rear cross member 4 is disposed at a rear side the battery 3 and extends in the vehicle width direction. The support member 5 is disposed at a rear side of the rear cross member 4 and configured to support the deck board 1. Both the rear cross member 4 and the support member 5 are disposed below the deck board 1. The rear panel 6 is disposed at a rear side of the support member 5.

As shown in FIG. 1, the right-hand tool box 7R is located on the front and right side of the battery 3, and the left-hand tool box 7L and intercooler spray tank 8 are located on the left side of the battery 3. The material of the right-hand tool box 7R and the left-hand tool box 7L may be, for example, expanded polypropylene. The top surface of the left-hand tool box 7L has a number of recesses 71 that are concave towards the bottom. Tools such as a jack 72 can be stored in the recesses 71. The top surface of the right-hand tool box 7R also has recesses 71 that are concave towards the bottom. Tools such as a jack 72 and its accessories 73 can be stored in the recesses 71.

The deck board 1 is attached to the vehicle body in such a way that the front end can be rotated around a pivot axis. Therefore, by lifting the rear end of the deck board 1 with one's hands, it is possible to remove tools such as jack 72 stored in recesses 71 of right-hand tool box 7R and left-hand tool box 7L, or connect booster cables (not shown) to battery 3. Then, when the rear end of the deck board 1 is lowered, the deck board 1 is placed on the right-hand tool box 7R, the left-hand tool box 7L and the support member 5, and the deck board 1 is supported by the right-hand tool box 7R, the left-hand tool box 7L and the support member 5.

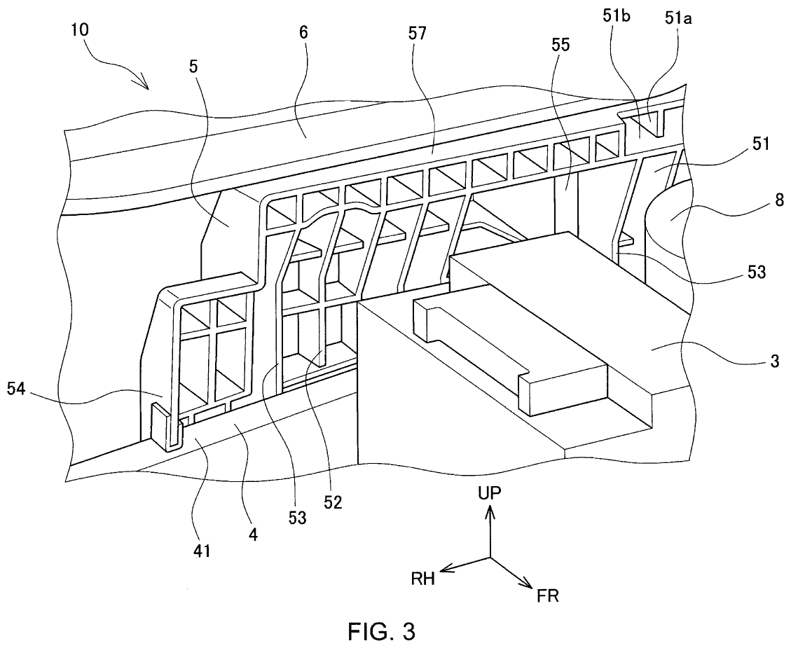

As shown in FIG. 2, the battery 3 and the support member 5 are mounted on a rear floor pan 9. And, a bumper reinforcement 11 is located behind the support member 5 and below the rear panel 6. A weather strip 61 is fixed to the rear of the rear panel 6. FIG. 2 shows the back door 2 closed. When the back door 2 is closed, the weather strip 61 contacts the back door 2 and can fill the gap between the back door 2 and the rear panel 6. FIG. 3 is an oblique view of the vehicle rear structure 10. FIG. 3 omits the deck board 1 and the right-hand tool box 7R in order to show the shape of the structure 51 of the support member 5. As shown in FIG. 3, the support member 5 has the structure 51 comprising a plurality of vertical ribs 51a extending in both the vertical direction and the vehicle longitudinal direction and a plurality of horizontal ribs 51b extending in both the vehicle width direction and the vehicle longitudinal direction, the plurality of vertical ribs 51a intersecting the plurality of horizontal ribs 51b in a forward part of the support member 5. Support member 5 is made of resin. Support member 5 has the grid-like structure 51, which ensures rigidity against the load applied by the luggage placed on the deck board 1.

The structure 51 extends forward to the rear of the rear cross member 4 in the part that is not located behind the battery 3. The structure 51 is formed such that the front end 52 of the portion of the structure 51 located directly behind the battery 3 rearwardly recessed relative to the front end of another portion that is not located directly behind the battery 3. As a result, as shown in FIG. 2, there is an open distance between the front end 52 of the structure 51 located directly behind the battery 3 and the rear end of the battery 3.

If the vehicle is rear-ended, the bumper reinforcement 11 shown in FIG. 2 may deform, and the support member 5 may be pushed forward. If the support member 5 is pushed forward in this way due to a rear-end collision, the front end 53 of the part of the support member 5 that is not located directly behind the battery 3 will contact the rear surface of the rear cross member 4. However, in the vehicle rear structure 10, the structure 51 has a portion located directly behind the battery 3, and a distance is secured in the vehicle longitudinal direction between the front end of the portion and the rear end of the battery 3, to prevent interference of the portion with the battery 3 even when the support member 5 is pushed forward due to a rear-end collision to a location where the support member 5 contacts a rear surface of the rear cross member 4. Therefore, even if the support member 5 is pushed forward due to a rear-end collision, the vehicle rear structure 10 can avoid interference with the battery 3. In addition, the vehicle rear structure 10 is formed such that the front end 52 of the portion of the structure 51 located directly behind the battery 3 is rearwardly recessed relative to the front end 53 of another portion that is not located directly behind the battery 3. As a result of the structure 51 being formed in this way, the vehicle rear structure 10 can improve the rigidity of the support member 5 against the load applied by the luggage placed on the deck board 1 in the part that is not directly located behind the battery 3.

On the right end of the support member 5, there is an overhang section 54 that protrudes forward on the upper side of the rear cross member 4. The overhang section 54 is in contact with the upper surface 41 of the rear cross member 4. In addition, on the left side of the support member 5, there is an overhang section 55 that protrudes forward on the upper side of the rear cross member 4. In FIG. 3, the overhang section 55 is hidden behind the battery 3 and cannot be seen, but it also contacts the upper surface 41 of the rear cross member 4. Furthermore, although not shown in the figure, there is also an overhang section 56 at the left end of the support member 5 that protrudes forward above the rear cross member 4 and contacts the upper surface 41 of the rear cross member 4, in the same way as the overhang sections 54 at the right end. The support member 5 is supported by the rear cross member 4, as these overhang sections 54 to 56 are in contact with the upper surface 41 of the rear cross member 4.

As shown in FIG. 2, the upper surface 57 of the support member 5 protrudes above the rear cross member 4. Therefore, when a load is placed on the deck board 1, a load is applied in the direction that causes the support member 5 to collapse forward. Because the support member 5 are supported by the rear cross member 4, with the three overhang sections 54 to 56 contacting the upper surface 41 of the rear cross member 4, the vehicle rear structure 10 can improve its performance to support the support member 5 so that they do not collapse forward against the load applied by the luggage loaded on the deck board 1.

### SUPPLEMENTAL INFORMATION OF EMBODIMENT

The vehicle rear structure in this disclosure is not limited to the above-described embodiments, and may be implemented in various forms within the scope of the gist of this disclosure. For example, the battery may be disposed in the vehicle width direction. In addition, the intercooler spray tank may not be installed. In addition, the number of support members that ride up may be other than three.

1. A vehicle rear structure, comprising:
a battery disposed under a deck board constituting a floor of a rear luggage room in a vehicle;
a rear cross member which is disposed at a rear side of the battery and extends along the vehicle width direction; and
a support member which is disposed at a rear side of the rear cross member and configured to support the deck board, wherein
the support member has a structure comprising a plurality of vertical ribs extending in both the vertical direction and the vehicle longitudinal direction and a plurality of horizontal ribs extending in both the vehicle width direction and the vehicle longitudinal direction, the plurality of vertical ribs intersecting the plurality of horizontal ribs in a forward part of the support member; and
the structure has a portion located directly behind the battery, and a distance is secured in the vehicle longitudinal direction between the front end of the portion and the rear end of the battery, to prevent interference of the portion with the battery even when the support member is pushed forward due to a rear-end collision to a location where the support member contacts a rear surface of the rear cross member.

2. The vehicle rear structure according to claim 1, wherein the structure is formed such that the front end of the portion of the structure located directly behind the battery is rearwardly recessed relative to the front end of another portion that is not located directly behind the battery.

3. The vehicle rear structure according to claim 1, wherein a portion of the support member is designed to contact an upper surface of the rear cross member for allowing the support member to be supported by the rear cross member.

4. The vehicle rear structure according to claim 2, wherein a portion of the support member is designed to contact an upper surface of the rear cross member for allowing the support member to be supported by the rear cross member.
